(19) United States
(12) Patent Application Publication
(10) Pub. No.: US 2017/0293646 A1
(43) Pub. Date: Oct. 12, 2017

(54) APPARATUS AND METHODS FOR OUT OF ORDER ITEM SELECTION AND STATUS UPDATING

(71) Applicant: Imagination Technologies Limited, Kings Langley (GB)

(72) Inventors: Ranjit J. Rozario, San Jose, CA (US); Sudhakar Ranganathan, Santa Clara, CA (US)

(21) Appl. No.: 15/092,728

(22) Filed: Apr. 7, 2016

(51) Int. Cl. G06F 17/30

(52) U.S. Cl. CPC G06F 17/30324; G06F 17/30371

(57) ABSTRACT

An apparatus, system, and method provide a way for tracking the age of items stored within a queue. An apparatus includes an item storage array and an array of age-tracking bits. The item storage array stores data of valid items stored in the queue. The array of age-tracking bits is associated with valid items stored in the queue. Age-tracking bits associated with a subset of items in the queue are set to a first value when the subset of items is older than other items in the queue. The younger items in the queue correspond to the age-tracking bits set to the first value. Other age-tracking bits associated with the subset of items in the queue are set to a second value when the subset of items is younger than other items in the queue. The older queue items correspond to the age-tracking bits set to the second value.

### FIELD OF THE INVENTION

Various configurations of the current invention relate generally to apparatus, systems, and methods for storing items in a queue. More particularly, the apparatus, systems, and methods relate to a queue that tracks the age of items within a queue. Specifically, the apparatus, systems, and methods provide for a queue that allows for items to be removed from the queue in a different order than how the items were placed in the queue.

### BACKGROUND OF THE INVENTION

In a processor, buffers are often provided between different functional units. In many cases, these buffers are implemented as a queue, which has an implicit relative ordering of slots in the queue. Items to be buffered arrive (or are stored) serially to the queue. In such a queue, the relative order of the items in queue represents a relative order of arrival (i.e., for every item in the queue, it is possible to determine whether any other item arrived earlier or later than that item simply by that item's relative position in the queue).

Other buffers may implement a First In First Out (FIFO) priority scheme. However, in situations where items may become ready for further processing out of an order in which they arrive, maintaining FIFO priority delays further processing of some items that are ready to be used within a processor. Thus, it may be desirable to be able to pick items from a buffer out of FIFO order. However, at times it may be desirable to pick an oldest item from among items that are ready to be output from the buffer.

One way to maintain relative age of items in a queue, in which items may leave the queue out of FIFO order is to compact later-arriving items into the slot(s) that were vacated. As long as a relative order of the items does not change, the order continues to represent the correct arrival order of the items. Newly arriving items are appended to the first empty slot at the back of the queue. However, such compaction requires consuming power and time to move items through the queue. Also, it is generally the case that items close to the front of the queue are more likely to become ready for retirement or removal from the queue, so as a queue becomes larger, items may need to be repeatedly shifted to the front.

Another way to track relative age of items in a queue is to maintain a counter for each slot in the queue. For example, if counters are incremented when an item enters the queue, then an item in the slot with the highest counter value is the oldest. When an item leaves a slot, the counter for that item is reset. When a new item arrives, an empty slot can be selected and then the counter for that slot again starts to be incremented. Implementing such a counter scheme requires maintaining a counter value for each queued item. In practice, a size of the registers to store each count must be maintained. The count should not roll over while items age since that would corrupt the aging information. Thus, the register holding the count needs to be sized according to an expected maximum amount of cycles that a given item may remain in the queue. If a queue has only a few slots, and a maximum delay is small, then implementing such a counter scheme is relatively low cost. However, for a larger queue, or in situations where a maximum delay is potentially large, implementing a counter scheme is expensive. What is needed is a better queue.

### SUMMARY OF THE INVENTION

One embodiment is an apparatus for tracking the age of items stored within a queue in a processor. In one configuration, an apparatus includes an item storage array and an array of age-tracking bits. The item storage array stores data associated with valid items stored in the queue. Age-tracking bits associated with a subset of items in the queue are set to a first value when the subset of items is older than other items in the queue. The younger items in the queue correspond to the age-tracking bits set to the first value. Other age-tracking bits associated with the subset of items in the queue are set to a second value when the subset of items is younger than other items in the queue. Older queue items correspond to the age-tracking bits set to the second value. The queue may include picker logic for finding an oldest item in the queue based on the array of age-tracking bits. In other configurations, the subset of items in the queue may correspond to single items within the queue.

Another embodiment is a method of tracking items in a queue which may be part of a microprocessor. The method begins by storing a particular item into an item storage array portion of the queue that stores data associated with valid items stored in the queue. For example, an opcode ID, an address, a ready bit, a valid bit and/or other data associated with an item may be stored as an entry in the item storage array. In one configuration, the queue may be part of a load and store unit and may store parts of addresses and other portions of load and store instructions. Age-tracking bits associated with the particular item are set to a first value to indicate the particular item is older than other items (or entries) in the queue. Younger queue items correspond to the age-tracking bits set to the second value. Similarly, other age-tracking bits associated with the particular item are set to a second value to indicate the particular item is younger than other items in the queue. Older queue items correspond to the age-tracking bits set to the second value. The values may be binary values of zero “0” and one “1”. An age of the particular item in the queue is determined based, at least in part, on the age-tracking bits. As discussed below, Boolean logic in combination with comparators may be used to analyze the age-tracking bits to determine the oldest item in the queue or the age of any item in the queue relative to other items in the queue.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one example configuration of a queue with age-tracking bits.

FIGS. 2A-2L illustrate the operation of a queue with age-tracking bits.

FIG. 3 illustrates an example architecture of a queue within a processor.

FIG. 4 illustrates one example configuration of a queue with age-tracking bits that track groups of items within the queue.

FIGS. 5A-2F illustrate the operation of a queue with age-tracking bits that track groups of items within the queue.

FIG. 6 illustrates an example method of tracking ages of items within a queue using age-tracking bits.

FIGS. 7A and 7B illustrate one configuration of a processor in which a queue with age-tracking bits may operate.

Similar numbers refer to similar parts throughout the drawings.

### DETAILED DESCRIPTION OF THE DRAWINGS

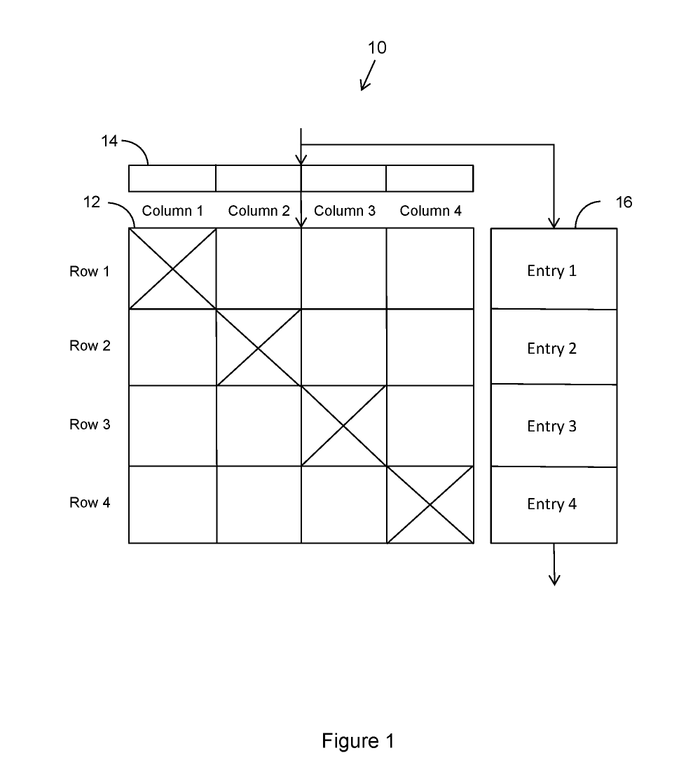

FIG. 1 illustrates one configuration of a queue 10 within a queue that keeps track of the relative age of each item stored in the queue 10 and also provides for the out-of-order removal (picking) of items from the queue that are not the oldest items in the queue. This type of queue 10 is useful for tracking various items in a processor that is speculatively executing instructions out of order but that needs to finally retire instructions in programming order. For example, it may be used to track items in a reorder buffer, a load-store unit, and the like. A load and store unit contains a queue such as queue 10 in FIG. 1 and stores load and store instruction addresses (or portions of those addresses) within queue 10 while keeping track of the ages of each load and store instruction relative to each other. For example, consider an old store instruction the has been speculatively executed to store data to a corresponding memory address but this store instruction has not yet actually written that memory address and has not yet retired in programming order. Next, a younger load instruction enters the processor and desires to read the same memory address that the older store instruction has speculatively executed but has not yet committed/written to memory. This younger load instruction will not want to read old data from that memory location because the older store in the queue contains newer data that has not yet been committed to that same memory address. Instead, the older store instruction will send (or bypass) the younger load instruction a copy of data that it is to write to that address before the older store instruction is to later retire in programming order before the younger load instruction. Now, the younger load instruction is able to speculatively execute with the correct data without stalling to wait for the newer/correct data.

Queue 10 of FIG. 1 contains an array of age-tracking bits 12, a valid bitmask register 14, and an item storage array 16. For simplicity, a four entry queue is illustrated; however, in other embodiments array 10 may store any number of entries. Valid bits in valid bitmask register 14 equal the number of items/entries in array 10 and each valid bit mask bit indicates which rows 1-4 of array 10 contain a valid entry. The leftmost bit in FIG. 1 may be set to a binary value of “1” if row 1 of queue 10 contains a valid entry and may contain a binary of “0” if row 1 is empty. The next bit to the right of the leftmost bit indicates if row 2 contains a valid entry and so on.

Item storage array 16 is the portion of array 10 that stores data associated with an item being stored in array 10. For example, if queue 10 is implemented as part of a load and store unit, then addresses or partial addresses and other information associated with a load or store instruction may be stored in corresponding entries 1-4 of item storage array 16.

As illustrated, array of age-tracking bits 12 is a 4 by 4 array of bits. As illustrated, one diagonal line of bits from the top left corner to the bottom right corner of array 12 is unimplemented and is marked with Xs through those locations. These bits are unimplemented because each bit in each row of the array of age-tracking bits 12 indicates if the queue entry of that row is older or younger than other row entries so that the diagonal of unimplemented bits does not need indicate if an item in a row is younger or older than itself. For simplicity, a 4 by 4 array of age-tracking bits 12 is illustrated; however, in other configurations, the size of this array may be any size, N×N. Notice that the array of age-tracking bits 12 is an efficient way of keeping track of the age of items in an array. For a 32-entry queue, 1024 (1K) of bits are needed minus 32 unimplemented diagonal bits. Later, a way of grouping items in the array together is explained that further reduces the number of age-tracking bits needed to track the age of each entry in a queue.

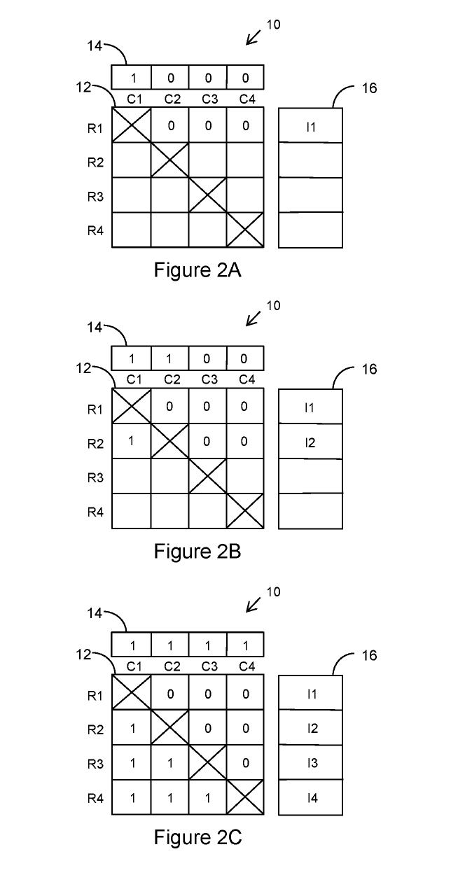

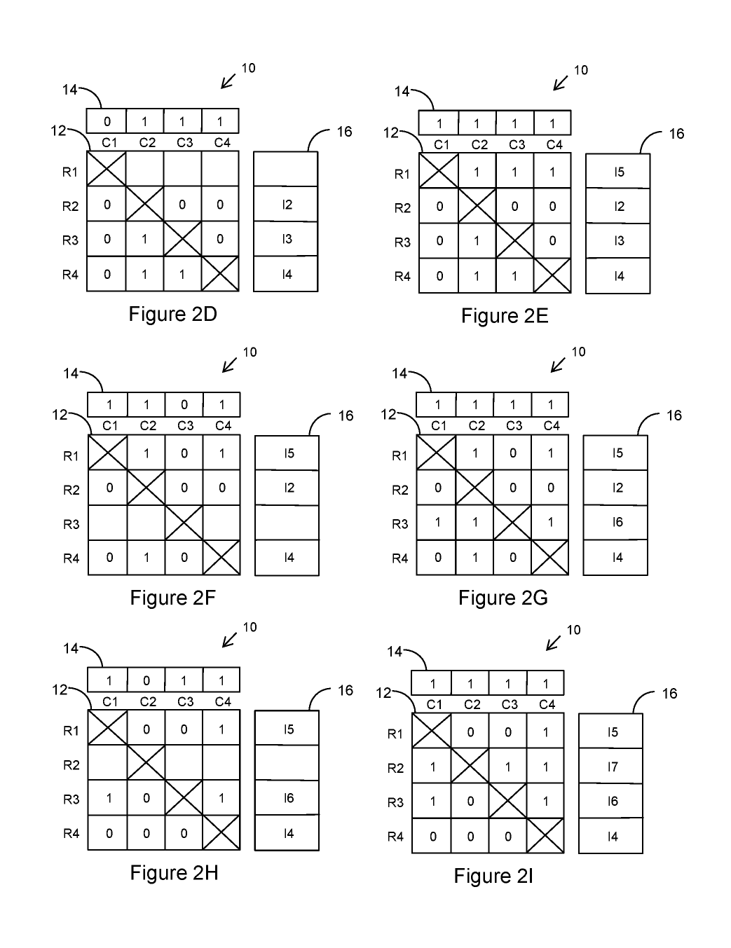

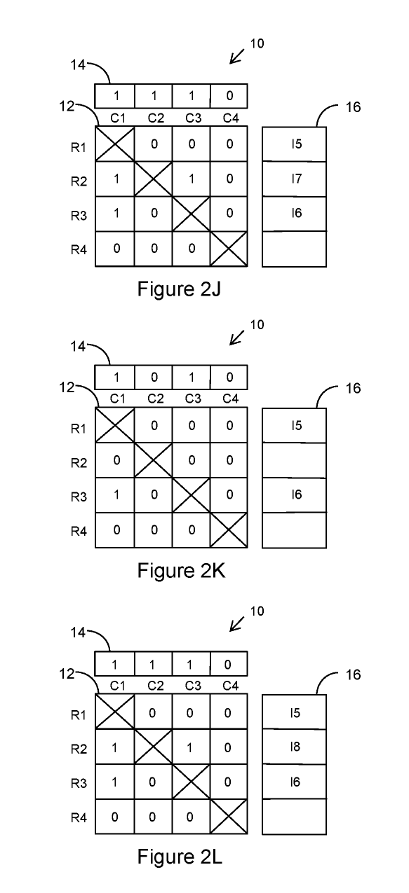

As mentioned, each bit in the array of age-tracking bits 12 indicates the age of an item in queue 10 with respect to other entries in queue 10. The row of age-tracking bits of the array of age-tracking bits 12 left of each item stored in item storage array 16 of queue 10 contain age information of other entries in queue with respect to the item stored in that row. FIG. 2A illustrates queue 10 just after item I1 has been placed into previously empty queue 10. The leftmost valid bitmask bit of the valid bitmask register 14 has been set to “1” indicating that row 1 contains a valid entry. Additionally, the bits of row 1 of the array of age-tracking bits 12 have all been set to “0”, indicating item I1 is the youngest entry in queue 10. FIG. 2B illustrates that item I2 has been placed in row 2 and the bit representing row 2 is set to “1” in the valid bitmask register 14. When item I2 is placed in queue 10, the value of the valid bitmask register 14 is copied into row 2 of the array of age-tracking bits 12. Referring to row 2, the value of “1” found in column 1 indicates that entry I1 of the queue is older than entry I2. The zeros in columns 3 and 4 indicate that entry I2 of queue 10 is younger than entries in rows 3 and 4 even though there currently are no current valid entries in rows 3 and 4. FIG. 2C illustrates queue 10 after entries I3 and I4 have been placed into rows 3 and 4, respectively.

FIG. 2D illustrates queue 10 after entry I1 in row 1 has been picked (removed) but before a new entry has been added to row 1. Clearing the leftmost valid bitmask bit of the valid bitmask register 14 and setting it to “0” indicates that row 1 does not contain a valid entry. The bits of column 0 are also reset to “0”. FIG. 2E illustrates that entry I5 has been placed into row 1 of item storage array 16. Again, leftmost valid bitmask bit of valid bitmask register 14 is set to “1” indicating that row 1 now, again, contains a valid entry. The valid bitmask register 14 is again copied into row 1 of the array of age-tracking bits 12 when item I5 is placed in row 1 of item storage array 16. Additionally, the leftmost valid bitmask bit of the valid bitmask register 14 is set. The “1 s” in row 1 indicate that item I5 of that row is younger than items in rows 2-4. FIG. 2F illustrates that item I3 has been picked from row 3. Item I3 has been picked from queue 10 out of order before item I2. The third bit of valid bitmask register 14 is reset to a value of “0” to indicate that row 3 no longer contains a valid entry. FIG. 2G illustrates that item I6 has been placed into row 3 of queue 10 and its corresponding bit of the valid bitmask register 14 has been set. When item I6 is placed in queue 10, the valid bitmask register 14 is again copied into row 3 of the array of age-tracking bits 12. FIG. 2H illustrates that item I2 has been picked from queue 10 with the second valid bitmask bit of valid bitmask register 14 being reset to “0” to indicate that there is no valid entry in row 2. FIG. 2I illustrates queue 10 after item I7 has been placed into row 2 of queue 10. Again, the bitmask register 14 has been copied into row 2 of the array of age-tracking bits 12.

FIG. 2J illustrates queue 10 after the current youngest entry I4 has been picked from row 4 of queue 10 and has not been replaced with another valid entry. Column 4 is set to zeros when item 4 is picked from row 4 and the fourth valid bit of the valid bitmask register 14 is set to “0” because there is no a valid entry in row 4. FIG. 2K illustrates queue 10 after the entry I7 has been picked out of order from row 2 of queue 10 and has not been replaced with another valid entry. Column 2 is set to zeros when item 7 is picked from row 2 and the second valid bit of the valid bitmask register 14 is set to “0” because there is no a valid entry in row 4. FIG. 2L illustrates queue 10 after an entry I8 has been written to the second row of the item storage array 16. Again, valid bitmask register 14 has been written to row 2 of the array of age-tracking bits 12.

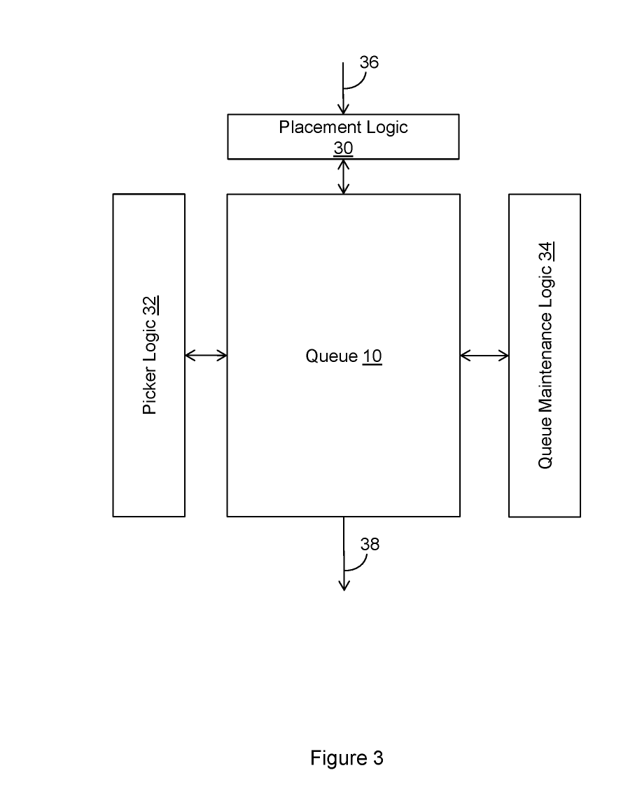

FIG. 3 illustrates one configuration of various logics that may work in combination with queue 10. “Processor” and “Logic”, as used herein, includes, but is not limited to, hardware, firmware, software and/or combinations of each to perform a function(s) or an action(s), and/or to cause a function or action from another logic, method, and/or system. For example, based on a desired application or need, logic and/or a processor may include a software-controlled microprocessor, discrete logic, an application specific integrated circuit (ASIC), a programmed logic device, a memory device containing instructions or the like. Logic and/or a processor may include one or more gates, combinations of gates, or other circuit components. Logic and/or a processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

In the configuration of FIG. 3, queue 10 is associated with placement logic 30, picker logic 32, and queue management logic 34. When an item arrives on input bus 36 to be placed in queue 10, placement logic 30 determines if there are one or more open entries in queue 10, allowing the new item to be placed in queue 10. For example, placement logic 30 may analyze the valid bitmask register in queue 10 to determine which entries do not have a valid entry and are empty. Based on this information, placement logic 30 may then select an open entry in item storage array 16, place the new item in that entry, update the valid bitmask register 14, and copy the valid bitmask register into the row of the array of age-tracking bits in queue 10 associated with the new entry.

When an item is ready to retire or otherwise ready to be removed from queue 10, picker logic 32 has the capability to find the oldest item in queue 10 or to find an item in queue 10 that may be ready to retire out of order and to place that item on output bus 38. Picker logic 32 may compare different age-tracking bits of the array of age-tracking bits 12 as discussed above to determine which entry in queue 10 is the oldest and may be a candidate to retire. Alternatively, picker logic 32 may be provided other information about an item in queue 10 that is to retire out of order. Picker logic 32 uses information about the oldest entry in queue 10 or information about an entry in queue 10 to be removed from queue 10 out of order to select the appropriate entry in queue 10 and may place that entry on output bus 38 as it is removed/retired/cleared from queue 10.

In some embodiments, queue maintenance logic 34 may assist placement logic 30 and picker logic 32 in placing and picking items from queue 10 and/or performing other useful functions. For example, when queue 10 is part of a load and store unit, addresses may be one item stored in queue 10. When provided an address, queue maintenance logic 34 may compare that address to addresses stored in queue 10 to determine if one or more addresses in queue 10 match that address. When one or more queue addresses match, it may be necessary for a store instruction associated with a matching queue address to forward/bypass its data to another instruction associated with the address to which it was matched. In other embodiments, portions or all of the queue maintenance logic 34 may be part of placement logic 30 and/or picker logic 32. Placement logic 30, picker logic 32, and/or queue maintenance logic 34 may implement comparison functions or other functionality as understood by those of ordinary skill in the art.

In one configuration, placement logic 30, picker logic 32, and/or queue management logic 34, when picking the oldest entry from queue 10 do not need to compare information of one queue entry to any other queue entry. Rather, each individual entry can independently look at it's own row of age bits to determine if there are any other entries that are older that it. If so, it outputs “0” indicating it is not the oldest entry. Otherwise, it outputs an indicator such as it's row number of the associated data indicating it is the oldest entry. These outputs of each of the entries may now simply be ORed together so that the oldest value is read out. This kind logic may be implemented essentially of AND gate and OR gate logic results in a very small number of gates and is very efficient in terms of area and speed.

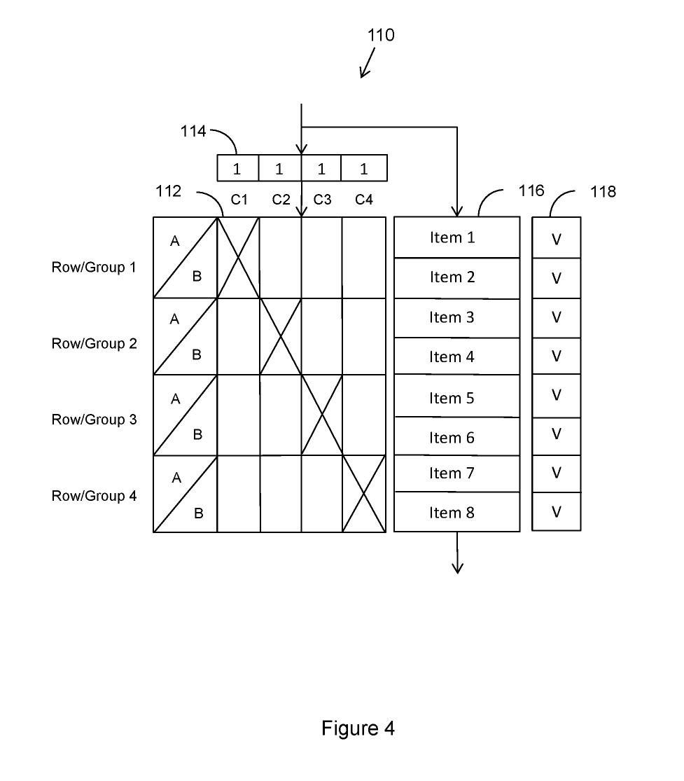

FIG. 4 illustrates another configuration of a queue 110 that groups two or more entries together into groups 1-4 to further reduce the number of bits in an array of age-tracking bits 112. Again, a 4 by 4 array of age-tracking bits 112 is implemented with the upper left to lower right diagonal of bits again unused. However, in this configuration, each row/group of the array of age-tracking bits 112 represents two slots A/B. Each slot A/B corresponds to one possible pair of entries that may be stored in queue 110. For example, FIG. 4 illustrates group 3 having item 5 stored in slot A and item 6 stored in slot B. Thus, the array of age-tracking bits 112 has the same number bits of the array of age-tracking bits 12 of FIG. 1 but may be used to track eight items of array 110 instead of four items as discussed above with reference to array 10 of FIG. 1. For example an array of age-tracking bits similar to FIG. 1 for a queue with 32 entries would require 32×32−32=992 bits; however, an array of age-tracking bits similar to FIG. 4 would only require 16×16−16=240 bits. Generally, fewer bits use less area and power and often perform faster than designs with a larger number of bits.

While using the array of age-tracking bits 112 to track multiple entries per group reduces its size, there may need to be some implied ordering as to how slots A/B within a group are written to and removed from array 110. In one configuration, and as discussed below, once the first slot, A, of a group is written to with a valid item, the next item written to array 110 must be must be written to slot B. Similarly, once slot A or B is removed from a group, no other item may be written to that group before both slots A and B are removed from that group. Of course, those of ordinary skill in the art will appreciate that in other configurations the group sizes may be larger than two bits and that array 110 and an array of age-tracking bits 112 may be other sizes than what is illustrated and describe herein.

Similar to array 10 of FIG. 1, array 110 of FIG. 4 includes a valid bitmask register 114 and an item storage array 116 performing similar functions to similar items in FIG. 1. Array 110 further includes a valid bit field 118 that sets a valid bit when an entry in array 110 is valid. As discussed below, valid bit field 118 aids in determining which slots/values within a group are valid.

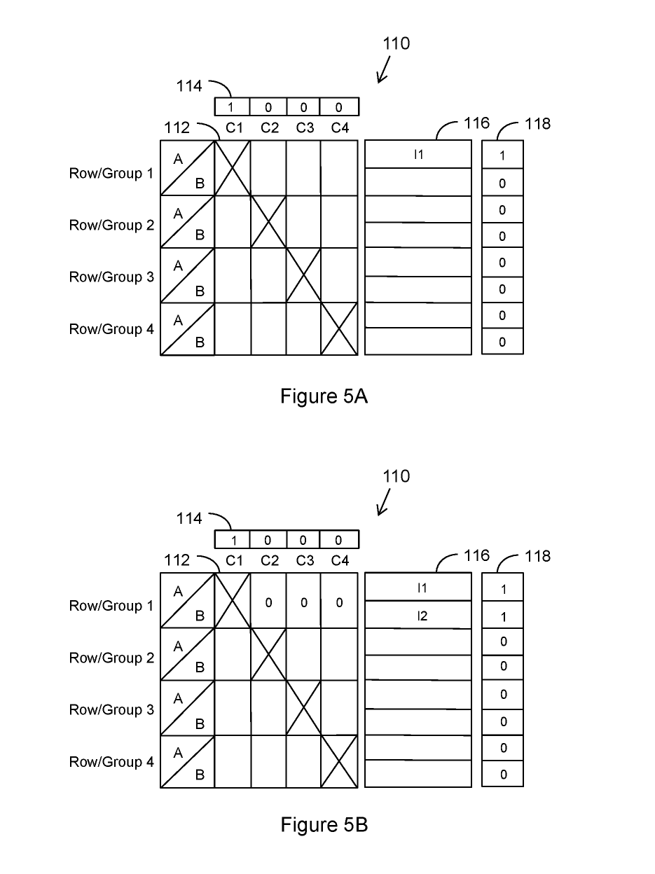

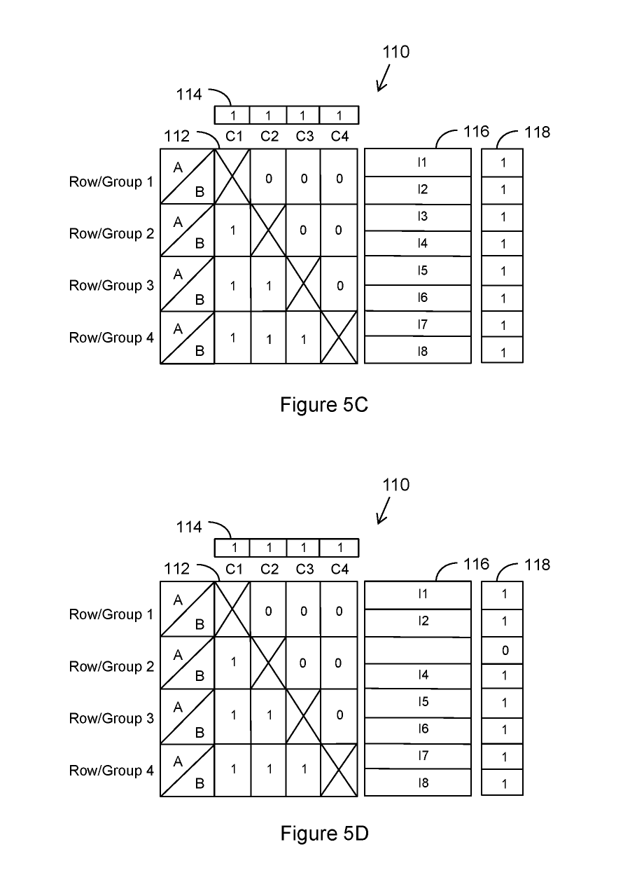

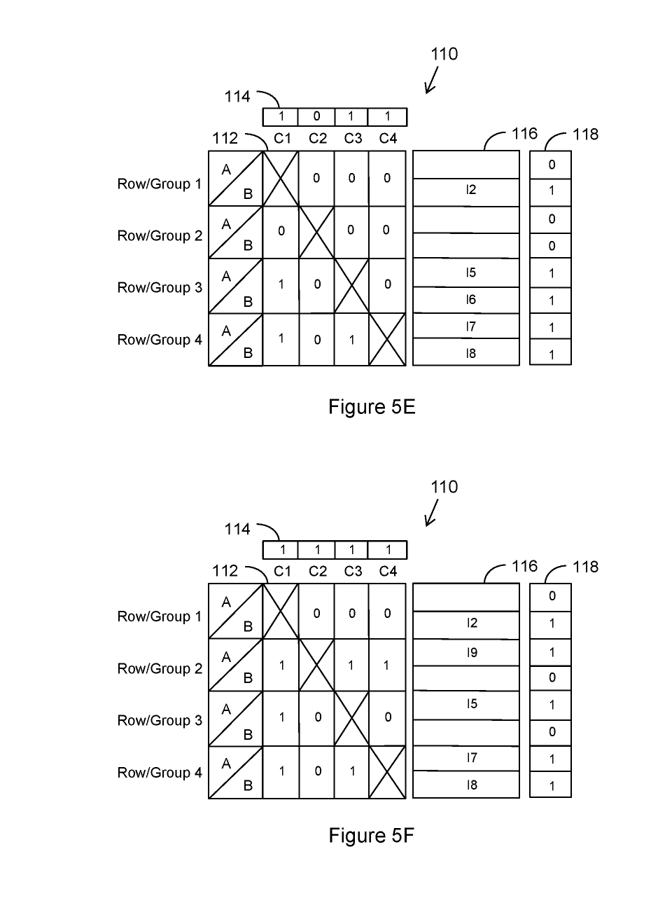

FIG. 5A illustrates array 110 with item 1 stored in group 1, slot A, with its corresponding valid bit set. The rest of array 110 is empty so that other valid bits in valid bit field 118 are not set to “1” and are instead set to “0” indicating that other than the valid entry “I1” in group 1, slot A, the other entries of array 110 are invalid. In order to ensure insure implicit ordering, once a group (group 1 in this example) has its slot A filled with a valid entry, then no other group may be filled with a valid entry until group 1 has its slot B filled with a valid entry. When an entry is written to group 1, slot A, the far left bit of the valid bitmask register 114 is also set to a value of “1”. In other configurations, the far left bit of the valid bitmask register 114 may not be set to a value of “1” until all slots A/B of group 1 are filled with valid entries. FIG. 5B illustrates group 1, slot B, filled with valid entry I2 and its corresponding valid bit set in the valid bit field 118.

FIG. 5C illustrates queue 110 with valid items I1 through I8 loaded into queue 110. As illustrated in FIG. 5C, group 1 is the oldest row/group because it contains three “0” bits in its row of age-tracking bits. Group 2 is the second oldest row/group because it contains two “0” bits and one “1” bit in its row of age-tracking bits, while Group 3 is the third oldest row/group because it contains one “0” bits and two “1” bits in its row of age-tracking bits. Group 4 is the youngest row/group because it contains three “1” bits in its row of age-tracking bits

FIG. 5D illustrates queue 110 after item I3 has been picked (removed) from group 2, slot A of queue 110 out of order. In order to maintain implicit ordering of queue 110, once an item is picked from a group, nothing else may be written to that group until the other item(s) of that group have been picked and the group is empty. FIG. 5E illustrates queue 110 after item I1 has been picked from group 1, slot A, and item I4 has been picked from group 2, slot B. Because both slots of group 2 are now empty/invalid, column C2 now is filled will values of “0” and a value of “0” is written to the second position in valid bitmask register 114. Group 1 is the oldest row/group because it contains three values of “0” in its row of age-tracking bits while group 3 is the second oldest row/group with a single value of “1” and two values of “0”. Group 4 is the youngest row/group with two values of “1” bits and a single value “0” while Group 2 is empty with two invalid bits set for each of its slots A/B.

To maintain implicit ordering, the next item to be entered into queue 110 will be loaded into group 2, slot A, because it is the only empty group with two valid bits with a of value “0”. FIG. 5F illustrates item I9 loaded into group 2, slot A, as well as its valid bit set and position to of valid bitmask register 114 representing column 2 being set. Because group 2 again contains a valid entry, the valid bitmask register 114 is again copied into group 2 with three values of “1” indicating that this row/group is now the youngest row/group of queue 110. Also note that entry I6 of queue 110 has been removed from queue 110

Example methods may be better appreciated with reference to flow diagrams. While for purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

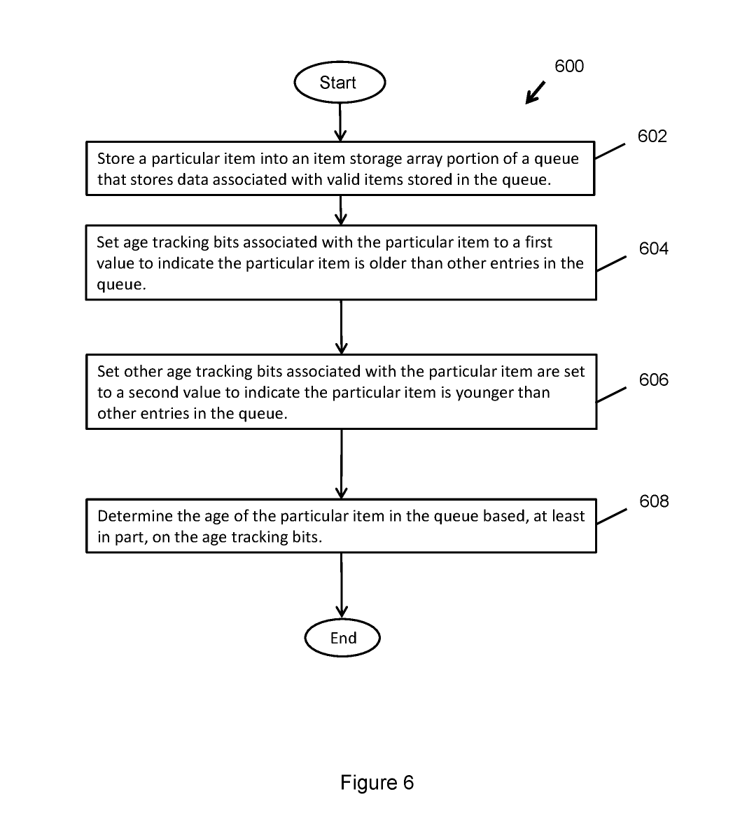

FIG. 6 illustrates a method 600 of tracking items in a queue which may be part of a microprocessor. The method 600 begins at 602 by storing a particular item into an item storage array portion of the queue that stores data associated with valid items stored in the queue. For example, an opcode ID, an address, a ready bit, a valid bit, and/or other data associated with an item may be stored as part of an entry in the item storage array. Age-tracking bits associated with the particular item are set to a first value at 604 to indicate the particular item is older than other entries in the queue. The younger items in the queue correspond to the age-tracking bits set to the first value. Other age-tracking bits associated with the particular item in the queue are set to a second value at 606 when the particular item is younger than other items in the queue. The older queue items correspond to the age-tracking bits set to the second value. As discussed above, the first and second values may be binary values of zero “0” and one “1”, respectively. An age of the particular item in the queue is determined at 608 based, at least in part, on the age-tracking bits. As discussed above, Boolean logic in combination with comparators may be used to analyze the age-tracking bits to determine the oldest item in the queue or the age of any item in the queue relative to another item in the queue. In some configurations, the age of any item in the queue may be determined solely by the age-tracking bits and valid entry bits when each entry in the queue is assigned its own set of tracking bits as discussed above with reference to FIG. 1 and FIGS. 2A-I.

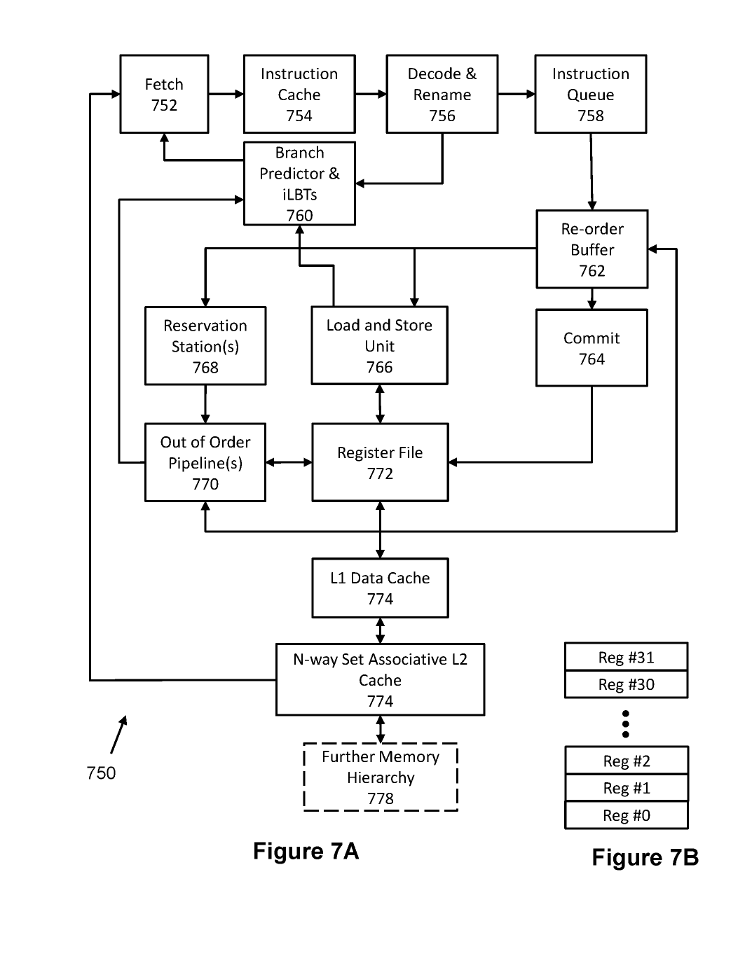

FIGS. 7A and 7B present an example block diagram of a processor 750 that can implement the disclosure. In particular, the load store unit (LSU) 766 can execute load and store instructions stored within a queue in the load store unit 766 in accordance with the disclosure to in part ensure memory coherency between load and store instructions.

The fetch logic 752 pre-fetches software instructions from memory that the processor 750 will execute. These pre-fetched instructions are placed in an instruction cache 754. These instructions are later removed from the instruction cache 754 by the decode and rename logic 756 and decoded into instructions that the processor can process. These instructions are also renamed and placed in the instruction queue 758. The decoder and rename logic 756 also provides information associated with branch instructions to the branch predictor and Instruction Translation Lookaside Buffers (ITLBs) 760. The branch predictor and ILTBs 760 predict branches and provide this branch prediction information to the fetch logic 752 so instructions of predicted branches are fetched.

A re-order buffer 762 stores results of speculatively completed instructions that may not be ready to retire in programming order. The re-order buffer 762 may also be used to unroll miss-predicted branches. The reservation station(s) 768 provides a location to which instructions can write their results without requiring a register to become available. The reservation station(s) 768 also provide for register renaming and dynamic instruction rescheduling. The commit unit 764 determines when instruction data values are ready to be committed/loaded into one or more registers in the register file 772. The load and store unit 766 monitors load and store instructions to be sure accesses to and from memory follows sequential program order, even though the processor 750 is speculatively executing instructions out of order. For example, the load and store unit 766 will not allow a load to load data from a memory location that a pending older store instruction has not yet written.

Instructions are executed in one or more out-of-order pipeline(s) 770 that are not required to execute instructions in programming order. In general, instructions eventually write their results to the register file 772. FIG. 7B illustrates an example register file with 32 registers Reg #0 through Reg #31. Depending on the instruction, data results from the register file 772 may eventually be written into one or more level one (L1) data cache(s) 774 and an N-way set associative level two (L2) cache 776 before reaching a memory hierarchy 778.

Modern general purpose processors regularly require in excess of two billion transistors to be implemented, while graphics processing units may have in excess of five billion transistors. Such transistor counts are likely to increase. Such processors have used these transistors to implement increasing complex operation reordering, prediction, more parallelism, larger memories (including more and bigger caches) and so on. As such, it becomes necessary to be able to describe or discuss technical subject matter concerning such processors, whether general purpose or application specific, at a level of detail appropriate to the technology being addressed. In general, a hierarchy of concepts is applied to allow those of ordinary skill to focus on details of the matter being addressed.

For example, high-level features, such as what instructions a processor supports conveys architectural-level detail. When describing high-level technology, such as a programming model, such a level of abstraction is appropriate. Microarchitecture detail describes high-level detail concerning an implementation of architecture (even as the same microarchitecture may be able to execute different ISAs). Yet, microarchitecture detail typically describes different functional units and their interrelationship, such as how and when data moves among these different functional units. As such, referencing these units by their functionality is also an appropriate level of abstraction, rather than addressing implementations of these functional units, since each of these functional units may themselves comprise hundreds of thousands or millions of gates. When addressing some particular feature of these functional units, it may be appropriate to identify substituent functions of these units, and abstract those, while addressing in more detail the relevant part of that functional unit.

Eventually, a precise logical arrangement of the gates and interconnect (a netlist) implementing these functional units (in the context of the entire processor) can be specified. However, how such logical arrangement is physically realized in a particular chip (how that logic and interconnect is laid out in a particular design) still may differ in different process technology and for a variety of other reasons. Many of the details concerning producing netlists for functional units as well as actual layout are determined using design automation, proceeding from a high-level logical description of the logic to be implemented (e.g., a “hardware description language”).

The term “circuitry” does not imply a single electrically connected set of circuits. Circuitry may be fixed function, configurable, or programmable. In general, circuitry implementing a functional unit is more likely to be configurable, or may be more configurable, than circuitry implementing a specific portion of a functional unit. For example, an Arithmetic Logic Unit (ALU) of a processor may reuse the same portion of circuitry differently when performing different arithmetic or logic operations. As such, that portion of circuitry is effectively circuitry or part of circuitry for each different operation, when configured to perform or otherwise interconnected to perform each different operation. Such configuration may come from or be based on instructions, or microcode, for example.

In all these cases, describing portions of a processor in terms of its functionality conveys structure to a person of ordinary skill in the art. In the context of this disclosure, the term “unit” refers, in some implementations, to a class or group of circuitry that implements the functions or functions attributed to that unit. Such circuitry may implement additional functions, and so identification of circuitry performing one function does not mean that the same circuitry, or a portion thereof, cannot also perform other functions. In some circumstances, the functional unit may be identified, and then functional description of circuitry that performs a certain feature differently, or implements a new feature, may be described. For example, a “decode unit” refers to circuitry implementing decoding of processor instructions. The description explicates that in some aspects such decode unit, and hence circuitry implementing such decode unit, supports decoding of specified instruction types. Decoding of instructions differs across different architectures and microarchitectures, and the term makes no exclusion thereof, except for the explicit requirements of the claims. For example, different microarchitectures may implement instruction decoding and instruction scheduling somewhat differently, in accordance with design goals of that implementation. Similarly, there are situations in which structures have taken their names from the functions that they perform. For example, a “decoder” of program instructions, that behaves in a prescribed manner, describes structure supporting that behavior. In some cases, the structure may have permanent physical differences or adaptations from decoders that do not support such behavior. However, such structure also may be produced by a temporary adaptation or configuration, such as one caused under program control, microcode, or other source of configuration.

Different approaches to design of circuitry exist. For example, circuitry may be synchronous or asynchronous with respect to a clock. Circuitry may be designed to be static or be dynamic. Different circuit design philosophies may be used to implement different functional units or parts thereof. Absent some context-specific basis, “circuitry” encompasses all such design approaches.

Although circuitry or functional units described herein may be most frequently implemented by electrical circuitry, and more particularly by circuitry that primarily relies on a transistor implemented in a semiconductor as a primary switch element, this term is to be understood in relation to the technology being disclosed. For example, different physical processes may be used in circuitry-implementing aspects of the disclosure, such as optical, nanotubes, micro-electrical mechanical elements, quantum switches or memory storage, magneto resistive logic elements, and so on. Although a choice of technology used to construct circuitry or functional units according to the technology may change over time, this choice is an implementation decision to be made in accordance with the then-current state of technology. This is exemplified by the transitions from using vacuum tubes as switching elements to using circuits with discrete transistors, to using integrated circuits, and advances in memory technologies, in that while there were many inventions in each of these areas, these inventions did not necessarily fundamentally change how computers fundamentally worked. For example, the use of stored programs having a sequence of instructions selected from an instruction set architecture was an important change from a computer that required physical rewiring to change the program, but subsequently, many advances were made to various functional units within such a stored-program computer.

Functional modules may be composed of circuitry where such circuitry may be a fixed function, configurable under program control or under other configuration information, or some combination thereof. Functional modules themselves thus may be described by the functions that they perform to helpfully abstract how some of the constituent portions of such functions may be implemented.

In some situations, circuitry and functional modules may be described partially in functional terms and partially in structural terms. In some situations, the structural portion of such a description may be described in terms of a configuration applied to circuitry or to functional modules, or both.

Although some subject matter may have been described in language specific to examples of structural features and/or method steps, it is to be understood that the subject matter defined in the appended claims is not necessarily limited to these described features or acts. For example, a given structural feature may be subsumed within another structural element, or such feature may be split among or distributed to distinct components. Similarly, an example portion of a process may be achieved as a byproduct or concurrently with performance of another act or process, or may be performed as multiple, separate acts in some implementations. As such, implementations according to this disclosure are not limited to those that have a 1:1 correspondence to the examples depicted and/or described.

Above, various examples of computing hardware and/or software programming were explained, as well as examples of how such hardware/software can intercommunicate. These examples of hardware or hardware configured with software and such communication interfaces provide means for accomplishing the functions attributed to each of them. For example, a means for performing implementations of software processes described herein includes machine-executable code used to configure a machine to perform such process. Some aspects of the disclosure pertain to processes carried out by limited configurability or fixed-function circuits and in such situations, means for performing such processes include one or more of special purpose and limited-programmability hardware. Such hardware can be controlled or invoked by software executing on a general purpose computer.

Implementations of the disclosure may be provided for use in embedded systems, such as televisions, appliances, vehicles, personal computers, desktop computers, laptop computers, message processors, hand-held devices, multi-processor systems, microprocessor-based or programmable consumer electronics, game consoles, network PCs, minicomputers, mainframe computers, mobile telephones, PDAs, tablets, and the like.

In addition to hardware embodiments (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer-readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL), and so on, or other available programs, databases, and/or circuit (i.e., schematic) capture tools. Embodiments can be disposed in computer usable medium including non-transitory memories such as memories using semiconductor, magnetic disk, optical disk, ferrous, resistive memory, and so on.

As specific examples, it is understood that implementations of disclosed apparatuses and methods may be implemented in a semiconductor intellectual property core, such as a microprocessor core, or a portion thereof, embodied in a Hardware Description Language (HDL), that can be used to produce a specific integrated circuit implementation. A computer readable medium may embody or store such description language data, and thus constitute an article of manufacture. A non-transitory machine readable medium is an example of computer-readable media. Examples of other embodiments include computer readable media storing Register Transfer Language (RTL) description that may be adapted for use in a specific architecture or microarchitecture implementation. Additionally, the apparatus and methods described herein may be embodied as a combination of hardware and software that configures or programs hardware.

Also, in some cases, terminology has been used herein because it is considered to more reasonably convey salient points to a person of ordinary skill, but such terminology should not be considered to imply a limit as to a range of implementations encompassed by disclosed examples and other aspects. A number of examples have been illustrated and described in the preceding disclosure. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example” and so on, indicate that the embodiment(s) or example(s) so described may include a particular feature, structure, characteristic, property, element, or limitation, but that not every embodiment or example necessarily includes that particular feature, structure, characteristic, property, element, or limitation.

What is claimed is:

1. An apparatus for tracking ages of items in a queue within a processor comprising:
an item storage array configured to store data associated with valid items stored in the queue; and
an array of age-tracking bits configured to be associated with valid items stored in the queue, wherein age-tracking bits associated with a subset of items in the queue are configured to be set to a first value when the subset of items is older than other items in the queue, wherein the younger items in the queue are associated with the age-tracking bits set to the first value, wherein other age-tracking bits associated with the subset of items in the queue are configured to be set to a second value when the subset of items is younger than other items in the queue, wherein the older items in the queue are associated with the age-tracking bits set to the second value.

2. The apparatus of claim 1 wherein the queue is configured to remove valid items from the queue that are younger than other valid items in the queue.

3. The apparatus of claim 1 further comprising:
picker logic configured to find an oldest item in the queue based on the array of age-tracking bits.

4. The apparatus of claim 1 wherein the subset of items is a single item stored in the queue with a plurality of other single items.

5. The apparatus of claim 1 wherein the array of age-tracking bits further comprise:
an N by N array with rows of bits and columns of bits where N is an integer value corresponding to a number of items that the queue is configured to store.

6. The apparatus of claim 5 wherein the item storage array further comprises:
a vertical M by N array of bits configured to store N items where M is an integer, wherein each row of bits of the array of age-tracking bits indicates whether an item stored in the same row of the item storage array is younger or older than other valid items stored in the queue.

7. The apparatus of claim 1 further comprising:
a valid bitmask register with bits configured to be set to indicate which items in the item storage array are valid.

8. The apparatus of claim 7 wherein the subset of items is a single item stored in the queue, and wherein when the single item is placed into the queue the valid bitmask register is at least partially copied into a row of the array of age-tracking bits associated with single item.

9. The apparatus of claim 1 wherein the subset of items further comprises:
two or more items stored in the queue and the subset of items is stored in a first group of items within the queue.

10. The apparatus of claim 9 further comprising:
placement logic configured to only place a first one of the subset of items into the first group of items when the group of items is empty.

11. The apparatus of claim 10 wherein the placement logic is configured to after the first one of the subset of items is placed into the first group of items not to place a second item into other locations of the queue until the first group of items is full.

12. The apparatus of claim 1 wherein the first value is a binary value of zero “0” and the second value is a binary value of “1”.

13. The apparatus of claim 1 wherein the queue is implemented in a load store and unit of a processor.

14. The apparatus of claim 13 wherein the item storage array further comprises:
locations configured to store at least portions of addresses corresponding to load and store instructions, and
match logic configured to find at least portions of addresses in the item storage array matching an address value.

15. A method of tracking items in a queue comprising:
storing a data of particular item into an item storage array configured to store data associated with valid items stored in the queue; and
setting age-tracking bits associated with the particular item to a first value to indicate the particular item is older than other items in the queue, wherein the younger items in the queue correspond to the age-tracking bits set to the first value;
setting other age-tracking bits associated with the particular item to a second value to indicate the particular item is younger than other items in the queue, wherein the older items in the queue correspond to the age-tracking bits set to the second value, and wherein the age-tracking bits can only be one of the first value and the second value; and
determining an age of the particular item in the queue based, at least in part, on the age-tracking bits.

16. The method of tracking items in a queue of claim 15 wherein the item storage array and the age-tracking bits associated with the particular item form one row of the queue.

17. The method of tracking items in a queue of claim 16 wherein the setting age-tracking bits associated with the particular item are set to a first value and a second value further comprises:
copying a valid bitmask register into the one row of the queue at a time the particular item is entered into the queue, wherein the valid bitmask register indicates which items in the queue are valid.

18. The method of tracking items in a queue of claim 15 wherein the age-tracking bits associated with the particular item in the queue form one row of a two-dimensional array of age-tracking bits, wherein each row of the array of age-tracking bits is associated with a location for storing an item in the queue and further comprising:
when removing the particular item from the queue, setting a column of age-tracking bits of the array of age-tracking bits associated with the age of the particular item to the first value.

19. The method of tracking items in a queue of claim 15 wherein the particular item is part of a first group of items within the queue that is a subgroup of items within the queue, wherein the storing a particular item into an item storage array further comprises:
storing a particular item into an item storage array only when the first group of items completely empty.

20. The method of tracking items in a queue of claim 15 wherein the age-tracking bits represent one of two binary values.
